(19) United States
(12) Patent Application Publication
(10) Pub. No.: US 2024/0288848 A1
(43) Pub. Date: Aug. 29, 2024

(54) GENERATING AND EXECUTING ENCRYPTED PROGRAM INSTRUCTIONS BY MEANS OF A DIGITAL CONTROL DEVICE

(71) Applicant: Siemens Aktiengesellschaft, München (DE)

(72) Inventors: MATTHIAS BAUER, Neustadt an der Aisch, Bayern (DE); RONNY HOPF, Klingenthal (DE); LARS IMMENROTH, Zwickau (DE); GUIDO SEEGER, Baiersdorf (DE)

(73) Assignee: Siemens Aktiengesellschaft, München (DE)

(21) Appl. No.: 18/569,982

(22) PCT Filed: May 24, 2022
(86) PCT No.: PCT/EP2022/063948

§ 371 Date: Dec. 13, 2023

(30) Foreign Application Priority Data
Jun. 14, 2021 (EP) 21179270.0

(51) Int. Cl. G05B 19/4097

(52) U.S. Cl. CPC G05B 19/4097; G05B 2219/34343; G05B 2219/36542

(57) ABSTRACT

A method for operating a digital control device, and a digital control device, for controlling a manufacturing machine for manufacturing a workpiece, are disclosed. In the method, workpiece data are provided on the digital control device, and CAM software is provided on the digital control device. Program instructions for manufacturing the workpiece are generated by the manufacturing machine by the CAM software in accordance with the workpiece data. The program instructions are executed by the digital control device for controlling the manufacturing machine for manufacturing the workpiece. In order to protect the control program for the digital control device against unauthorized access, the generated program instructions are saved in encrypted form in a non-volatile memory of the digital control device and are only decrypted again immediately before the execution in a volatile memory of the NC core of the digital control device.

The invention relates to a method for operating a numerical control facility for controlling a manufacturing machine for manufacturing a workpiece, wherein workpiece data is provided on the numerical control facility, wherein CAM software is provided on the numerical control facility, wherein program instructions for manufacturing the workpiece are generated by means of the manufacturing machine by means of the CAM software in accordance with the workpiece data and wherein the program instructions are processed by the numerical control facility for controlling the manufacturing machine for manufacturing the workpiece.

The invention also relates to a numerical control facility for performing the method.

Furthermore, the invention relates to a manufacturing machine system, comprising a numerical control facility for performing the method and a manufacturing machine connected to the numerical control facility.

As a rule, the manufacturing process of a workpiece to be manufactured starts with the modeling of the workpiece on a CAD system (Computer Aided Design). The geometric data of the workpiece to be produced which is determined in this way with the help of the CAD system is forwarded as an input variable to a CAM system (Computer Aided Manufacturing). With the help of the CAM system, the paths for a tool, along which the tool moves relative to the workpiece during the manufacturing process, are determined from the geometric data of the workpiece to be manufactured and the later configuration of the manufacturing machine, as well as, if applicable, the geometric data of a blank, which forms the starting part for the manufacturing process later on the manufacturing machine. For example, the milling paths to be traveled by a milling machine to produce the workpiece to be manufactured from the blank are determined for milling.

In this way, the movements of one or more tools which are necessary for the manufacture of the workpiece are determined by the CAM system and made available to a so-called post-processor as input variables.

In connection with the invention, possible manufacturing methods are not limited to material-removing methods (milling, turning, drilling, grinding, etc.) here, but material-applying manufacturing methods (3D printing, welding, etc.) are also included.

Accordingly, as diverse as the manufacturing methods are the manufacturing machines used for this purpose. For example, production machines, machine tools, 3D printing machines, robots, etc. are suitable for manufacturing.

The post-processor, which is usually in the form of a program running on a computer, generates the control program for this specific manufacturing machine from the trajectories determined by the CAM system and the configuration of the specific manufacturing machine with which manufacturing is to take place.

In a manufacturing machine in the form of a machine tool, the numerical control facility is usually referred to as a CNC control system (Computerized Numerical Control) or a numerical control and the control program also as a parts program, an NC parts program or a NC program.

By means of the CNC control system in conjunction with the corresponding parts program, the desired workpiece is finally manufactured from the blank on the machine tool concerned. For this purpose, the CNC control system converts the trajectories stored in the parts program into interpolated movements of the individual machine axes, so that the tool is moved in the desired way relative to the workpiece.

The control program or parts program is usually available in the form of a file which contains program instructions (commands) written in ASCII key line by line in succession in DIN code, in particular the so-called G code. Such a command (for example G3 X115 Y113.3 I-43 J25.52), also called a set, can, for example, consist in moving a tool, for example a milling cutter, along a section of a circular path to a target position in order to mill out a recess from the blank, for example. The individual commands of the parts program are later read in by the numerical control facility of the machine tool. The numerical control facility calculates position setpoint values X_{soll_n} for each n drive of the drive system of the machine tool according to the commands of the parts program and assigns them to the drives accordingly. A regulator facility, which is also included in the numerical control facility, ensures that the determined position setpoint values X_{soll_n} of the individual drives (axes) are also adjusted accordingly.

The procedure described above and the necessary components are known, for example, from EP 2058717 A1.

There is a trend to shift complex manufacturing tasks, which were previously only achieved with independent (external) CAD/CAM tools, to the CNC control system for a machine tool. This CAD/CAM software then generates the parts program for controlling the machine tool concerned directly on the control system connected to the machine tool, on which it is then also processed.

Thus, it is known from WO 2016086344 A1 that the CAD data can be entered directly into the CNC control system and CAM software provided on the CNC control system generates a parts program directly on this CNC control system.

It is also known from EP 2620826 A1 that a parts program can be transmitted in encrypted form between an external CAM system and a CNC control system to protect against unauthorized access.

Document DE 102018214840 A1 relates to a method and a system for providing machining data to a numerical control system facility of a numerically controlled machine tool, comprising: Provision of machining data to an external data processing facility, the machining data comprising numerical control data, in particular one or more NC programs, on the basis of which a workpiece can be machined on the numerically controlled machine tool. The NC programs are generated by means of the external data processing facility and, if necessary, transferred to the numerical control facility in encrypted form.

Document EP 3534228 A1 describes a technology for preventing data leaks in a control apparatus which controls a control subject. In this case, encrypted data is generated externally to the control apparatus by means of a private key and a public key using data encrypted using the control apparatus using the public key and, if necessary, decrypted by means of the control apparatus using the private key for the encrypted data and stored in a volatile memory area which cannot be accessed externally.

Document US 2018094953 A1 discloses a distributed manufacturing platform which connects designers, manufacturers, carriers and other entities and simplifies the process of manufacturing and delivering new and existing products. A distributed ledger or blockchain can be used to record transactions, process smart contracts, and perform other operations to increase the transparency and integrity of the supply chain. Blockchain-enabled packaging can be used to track the movement and status of packages from manufacturing to transportation to delivery.

An object of the present invention is to protect a control program for a numerical control facility, in particular a parts program for a CNC control system, from unauthorized access.

This object is achieved by a method as claimed in claim 1, i.e. a method for operating a numerical control facility for controlling a manufacturing machine for manufacturing a workpiece comprising the following steps:
provision of workpiece data on the numerical control facility,
provision of CAM software on the numerical control facility,
generation of program instructions for manufacturing the workpiece by means of the manufacturing machine, the program instructions being generated in accordance with workpiece data by means of the CAM software,
encryption of the program instructions and storage of the encrypted program instructions in a non-volatile memory of the numerical control facility,
readout of the encrypted program instructions from the non-volatile memory, decryption of the encrypted program instructions and processing of the decrypted program instructions by the numerical control facility for controlling the manufacturing machine for manufacturing the workpiece.

By transferring a CAM algorithm into the numerical control facility, hereinafter also referred to as a “control facility”, the user can respond to changing conditions directly on the control unit of the control facility. Furthermore, the CAM algorithm has access to machine parameters of the manufacturing machine concerned, which are stored in the control facility, and can thus sometimes generate an optimized control program and thus a better manufacturing result. As the control program is created for the specific manufacturing machine, no post-processor is required.

The CAM algorithm generates the control program which is currently required for the production of a particular workpiece directly on the control facility. In particular, the control program comprises all the program instructions necessary for the production of the workpiece. This control program is then retained for further identical productions in the file system of the control facility. If relevant parameters should change, the previous control program is completely or partially overwritten by a changed control program.

The control program generated by the CAM algorithm on the control facility contains technological knowledge that must be protected. In particular, duplication of the control program on the control facility and thus the use of the same on other control facilities or manufacturing machines must be prevented.

The CAM algorithm generates an encrypted control program on the numerical control facility without storing individual program instructions unencrypted in a non-volatile memory. In particular, the CAM algorithm thus generates the parts program necessary for the production of a particular workpiece directly at the necessary time in the manufacturing process, specifically in encrypted form.

The method according to the invention has the advantage that control programs generated directly on the numerical control facility are also protected from unauthorized access. In particular, the control program is only present in encrypted form in a non-volatile memory of the numerical control facility so that, for example, it can be read from the non-volatile memory by a person with no knowledge of a key required for decryption but cannot be decrypted.

The CAM algorithm uses cryptographic algorithms for encryption in particular. After encryption, the program instructions in the control program can no longer be read without knowledge of the key. It is also no longer possible to carry out manipulations of the movement information behind the program instructions.

As encryption takes place directly on the numerical control facility, in particular an external facility for encryption of the parts program is also not required.

Nor are facilities for transporting the key from the external facility to the numerical control facility necessary, as would be the case with a control program generated and encrypted by an external CAD-CAM system.

Previous security solutions provide a password or authentication for access to the numerical control facility. However, all persons with access to the numerical control facility obtained thereby can also access the file system thereof and thus obtain access to sensitive data, for example parts programs. The invention can provide additional protection here.

Advantageously, the encrypted program instructions are decrypted in an NC kernel of the numerical control facility. The NC kernel, also referred to as the NCK (Numerical Control Kernel), is the part of the numerical control facility which controls the axes of the machine tool. Essential components of the NCK are: the interpreter, the interpolator and the regulators for the position, speed and acceleration of the individual drives (axes) of the machine tool. The NCK is a very sensitive area of the numerical control facility with regard to confidential data and is therefore particularly protected from external accesses.

Moreover, the decrypted program instructions are only stored in a volatile memory of the NCK, as a result of which they are overwritten immediately after their processing by new program instructions and thus deleted again. It would therefore be possible at most with very great effort to read the unencrypted program instructions from the NCK of the numerical control facility.

In addition, the NCK is further able to interpret the movement information and perform axis movements without functional restrictions. However, unencrypted control programs can also still be processed.

Advantageously, in addition to the processing of unencrypted control programs, the NC kernel can also read the encrypted file format and decrypt it again for processing. In this case, the decrypted program instructions or the resulting individual items of movement information are not stored in the file system of the control facility and are also not otherwise visible externally to the NC kernel but are only made available internally in the volatile memory of the NC kernel. The NC kernel is further able to interpret the movement information and perform axis movements without functional restrictions, as is also the case with unencrypted control programs.

The control programs previously generated by the integrated CAM algorithms and stored in unencrypted form in the file system can be stored in encrypted form from now on. The NC kernel “understands” this encrypted file format and can process it directly. This allows the manufacturing process to be protected directly on the manufacturing machine, in particular from data theft, espionage, changing of the production information through changing of the control program, sabotage or unintentional changes due to incorrect entries by an operator.

An operator with authorized access to the control facility can thus execute a control program generated and protected in the manner described, but cannot view, change or copy it.

One embodiment of the invention provides that the program instructions form individual sets or blocks from a plurality of sets of a control program for manufacturing the workpiece.

Both in the case of encryption and decryption, it can be advantageous not to encrypt or decrypt the complete control program for manufacturing the workpiece in one operation. Thus, the control program is generated by the CAM software set by set or block by block, so that it makes sense to already encrypt these sets or blocks while they are being generated or at least immediately thereafter, so that at no time are either the entire control program or larger parts thereof in unencrypted form on the numerical control facility.

The same applies to the decryption of the control program. Here, too, it is advantageous if the decryption is carried out set by set or block by block, so that only those program instructions of the control program are decrypted which are currently being processed by the numerical control facility or the processing of which is imminent.

In the aforementioned procedure, it is not absolutely necessary that in the case of block-by-block encryption and decryption, the blocks in the encryption correspond to the blocks in the decryption. For example, different sizes can be selected for the blocks concerned for encryption and decryption. The size of the blocks (also referred to as block length) can thus, if necessary, be adapted to different boundary conditions during encryption or decryption. In particular, the block length during decryption can also be adapted to boundary conditions of the numerical control facility for processing these blocks.

In one embodiment of the invention, decryption of the program instructions takes place as a function of the metadata associated with the program instructions. As a rule, this metadata does not apply to individual program instructions—which would, however, also be possible in principle—but to the entire control program. Preferably, the metadata determines that the decryption of the program instructions is restricted to a particular numerical control facility and/or a particular manufacturing or machine tool and/or a particular license. As a result, unauthorized execution of a control program can be further complicated in that even if the key for decryption of the control program is known, further conditions must be fulfilled so that the data can be visible or the control program concerned can be executed. The transmission and execution of the encrypted control program on another machine can thus also be prevented.

In one embodiment of the invention, only one key is used for encryption and decryption of the program instructions (symmetrical encryption). This has the advantage that only one key is needed, but this is used by both the encryption instance and the decryption instance.

Alternatively, however, the provision of asymmetrical encryption with a key pair, usually a so-called public key and a so-called private key, is also possible.

However, the encrypting body does not know the key for decryption.

In a preferred embodiment of the invention, encryption and decryption takes place using OpenSSL software, behind which there is generally a multiplicity of cryptographic functions for encryption and decryption, as well as various other tools in connection with encryption and decryption. OpenSSL is currently widely used and well known.

In the practical implementation of the invention, it proves to be advantageous if a DRM library (Digital Rights Management) is installed in the software area of the NCK, by means of which in particular key and rights management is organized. As a result, it is easier to manage the access rights and, in particular, the same or similar access rights can thus also be implemented in a simple manner on a plurality of numerical control facilities, for example within a factory.

Furthermore, an initially required authentication of a user can also be provided by means of the DRM library before access to the numerical control facility in general or protected content located therein is possible.

Furthermore, it is possible that the NCK first needs to be authenticated before it can access an encrypted control program, for example.

The aforementioned object is also achieved by a numerical control facility which carries out a method also referred to above.

Furthermore, the aforementioned object is achieved by a manufacturing machine system comprising such a numerical control facility and a manufacturing machine controlled thereby.

The invention is described and explained in more detail hereinafter with reference to exemplary embodiments. In the figures:

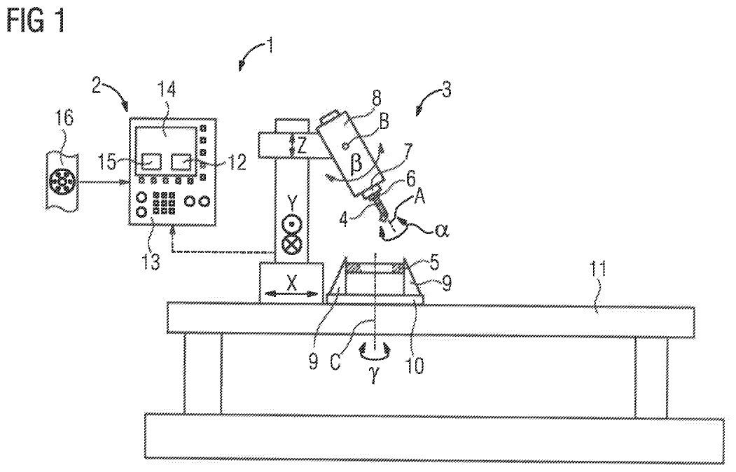

FIG. 1 shows a machine tool system according to the invention,

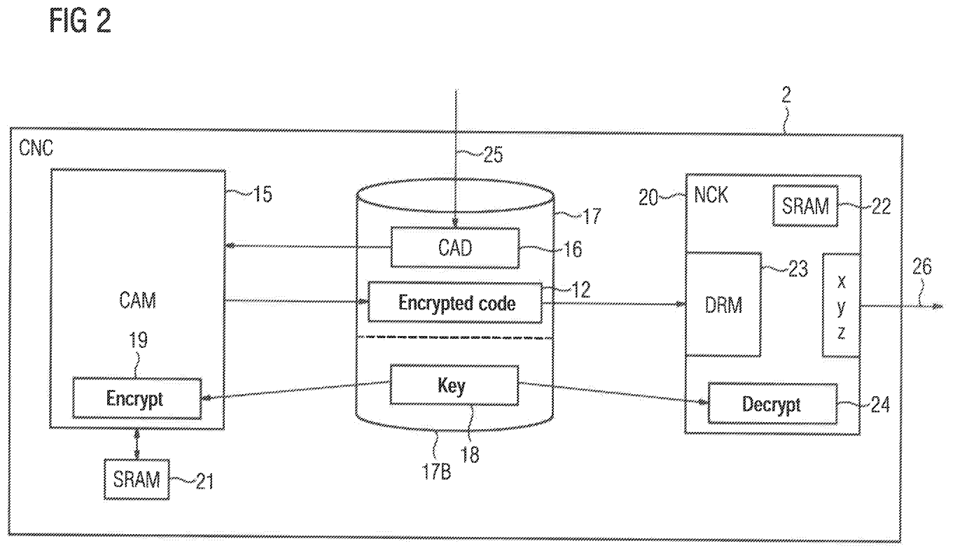

FIG. 2 shows a first embodiment of a CNC control system according to the invention,

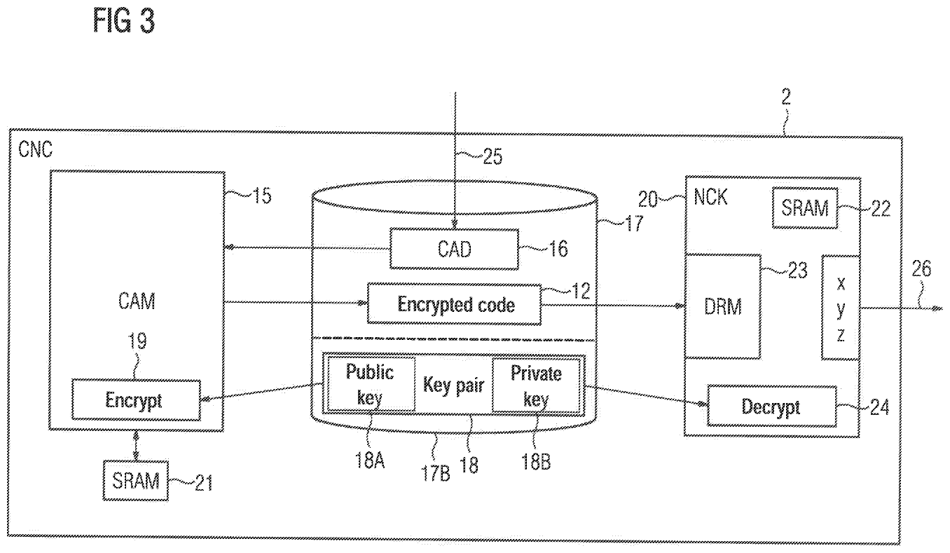

FIG. 3 shows a second embodiment of a CNC control system according to the invention,

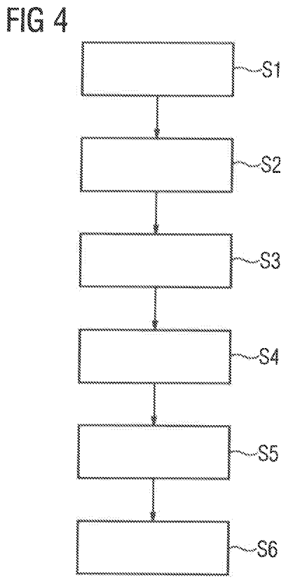

FIG. 4 shows method steps for carrying out a method according to the invention.

FIG. 1 shows a diagrammatic view of a manufacturing machine system in the form of a machine tool system 1, comprising a numerical control facility in the form of a CNC control system 2 and an associated manufacturing machine in the form of a machine tool 3. In the context of the exemplary embodiment, the machine tool 3 has six machine axes, by means of which a relative movement can be carried out between a tool, which is present in the form of a turning tool 4 in the context of the exemplary embodiment, and a workpiece 5. The tool 4 is clamped in a tool holder 6, which in turn is connected to a tool spindle 7 which is driven by a position-controlled motor 8. The workpiece 5 is fastened to a workpiece table 10 by clamping means 9.

The turning tool 4 can be moved translationally using the machine tool 3 shown in the exemplary embodiment with drives position-controlled in an X, Y and Z direction, not shown in FIG. 1 for the sake of clarity. In addition to the three linear axes, the machine tool 3 shown also comprises the two position-controlled rotary axes A (spindle axis) and B also shown in FIG. 1, with which the tool 4 can be rotated about the respective axis and also aligned in a position-controlled manner by the angular positions a and 0 relative to the workpiece 5.

Furthermore, the machine tool 3 has a third position-controlled rotary axis C, which runs parallel to the Z axis and with regard to which the workpiece table 10 is rotatably mounted relative to a stationary machine frame 11. As a result, the workpiece 5 can also be positioned in an angular position γ relative to the tool 4. Here, too, a representation of the drive has been omitted for the sake of clarity.

Depending on the machining to be carried out, a speed-controlled operation with regard to the rotary axes A and/or C is also possible in the machine tool 3 shown.

The machine tool 3 according to the exemplary embodiment thus has six machine axes (the 3 linear axes X, Y and Z and the 3 rotary axes A. B and C), i.e. it is a so-called 6-axis machine tool (6-axis machine) 3.

It should be noted at this point that a machine tool can, of course, also have more or less than six machine axes.

The machine tool 3 is connected to the CNC control system 2, which uses a control program in the form of a parts program 12 to determine position setpoint values x, y, z, α, β and γ for controlling a relative movement taking place between the tool 4 and the workpiece 5. The CNC control system 2 determines the position setpoint values using the parts program 12 in which the movement to be performed by the tool 4 and/or workpiece 5 is defined by program instructions in the form of so-called G-code which, in addition to G-instructions, may also comprise a multiplicity of other instructions (M, S, T instructions, etc.). Alternatively or additionally, the movement of the tool 4 and/or the workpiece 5 can also be predetermined by an operator in situ at the machine tool 3 by means of a manual control input via an operating facility 13 in conjunction with a display apparatus 14 of the CNC control system 2. For this purpose, the operating facility 13 has, in particular, input fields, buttons and rotary controls.

The parts program 12 is usually generated by an external CAM/CAD system (not shown) and a so-called post-processor (not shown) possibly connected downstream of the CAM/CAD system externally to the CNC control system 2 and transmitted from there to the CNC control system 2.

During the execution of the parts program 12, the CNC control system 2 generates position setpoint values x, y and z for the linear axes as well as α, β and γ (angular positions) for the rotary axes in a certain cycle, the interpolation cycle, and instructs them according to the drives of the axes. The tool 4 is moved with a predetermined orientation relative to the workpiece 5 along a movement path defined by the parts program 12 by means of these interconnected, interpolated position setpoint values. Regulators (position regulators, acceleration regulators, speed regulators, etc., not shown in FIG. 1) comprised by the CNC control system 2 ensure that the respective predetermined values are maintained within predetermined tolerances.

As a special feature, according to the exemplary embodiment, the CNC control system 2 according to the invention comprises CAM software 15, so that workpiece data, in particular CAD data 16 of the workpiece 5 to be manufactured, can be directly supplied to the CNC control system 2. The CAD data 16 is supplied to the CNC control system 2 in particular by a suitable storage medium (for example USB stick) or a network (LAN, WLAN, etc.).

FIG. 2 shows the components of the CNC control system 2, which are essential in connection with the invention, in a greatly simplified block diagram. By input means (not shown), workpiece data, in particular CAD data 16 of the workpiece 5 to be machined, are first made accessible to the CNC control system 2. For this purpose, for example, a CAD data file can be transmitted to the CNC control system 2 (indicated in the figure by the arrow 25) and stored in a non-volatile (permanent) memory 17 of the CNC control system 2. The CAD data file therefore comprises at least the CAD data 16 relating to the geometry of the finished workpiece 5. In the case of material-removing production, data relating to the workpiece blank is also included in the CAD data file.

In addition to the transmission of a CAD data file, however, other input possibilities for describing the workpiece 5 to be manufactured are also possible in the CNC control system 2, for example a manual input.

In particular, in connection with the transmission of a CAD data file, it is possible that this or the CAD data 16 present therein is transmitted in encrypted form to the CNC control system 2 and, for further processing in the CNC control system 2, are first decrypted by the latter.

For creating the parts program 12 for manufacturing the workpiece 5, CAM software 15 is present on the CNC control system 2 according to the invention, which is executed by means of suitable hardware components (processor, memory, etc.; not shown) and which generates program instructions (G-code) from the CAD data 16 for moving the tool 4 relative to the workpiece table 10 of the machine tool 3 or to the workpiece 5.

The CAD data 16 of the workpiece 5 to be manufactured serves as input data into this CAM software 15. It is stored in a non-volatile (permanent) memory 17 of the CNC control system 2. Furthermore, in a highly protected and “hidden” memory area 17B of this memory 17 (not visible to the user) there is a key 18 for encryption and decryption of data in conjunction with suitable encryption software, for example OpenSSL.

Advantageously, the generated program instructions are encrypted immediately after being generated and stored in encrypted form in the non-volatile memory 17 of the CNC control system 2. Encryption takes place by means of a “secret key” (key) 18 stored in the CNC control system 2 in a storage area 17B inaccessible to unauthorized users, in conjunction with the encryption routines (encrypt) 19 of the encryption software. Encryption can take place set by set or block by block, where block-by-block encryption means that a plurality of program instructions or sets of the parts program 12 are encrypted together in one encryption operation. Advantageously, before encryption the generated program instructions are only stored in a volatile memory (SRAM) 21 which is assigned to the CAM software and is inaccessible externally. The encrypted program blocks are finally stored in the non-volatile memory 17. This operation is repeated until all the program instructions and thus the complete parts program 12 (also referred to as “Enc. Code” in FIG. 2) is present in encrypted form in the non-volatile memory 17 of the CNC control system 2.

The parts program 12 is then executed in such a way that the encrypted program instructions of the parts program 12 are first decrypted in an NC kernel (NCK) 20 of the CNC control system 2. The NC kernel 20 is the part of the CNC control system 2 which ultimately generates position setpoint values for the axes (symbolized by x, y, z in FIG. 2) of the machine tool 3 and has corresponding position controllers. The position setpoint values are dependent on the drives of the machine tool, symbolized by the arrow 26.

Similar to encryption, decryption is also advantageously carried out in blocks of program instructions or sets of the parts program 12. For this purpose, a DRM (Digital Rights Management) decryption library 23 comprised by the NCK 20 reads the parts program 12 block by block and decrypts it by means of corresponding decryption routines (decrypt) 24 of the encryption software. The NCK 20 is also assigned an externally inaccessible volatile memory (SRAM) 22, in which sets or blocks of the parts program 12 which have already been processed by the machine tool 3 are overwritten by new sets or blocks. Analogously to encryption, the parts program 12 is therefore not completely decrypted in a memory of the CNC control system 2 at any time.

Furthermore, the decrypted program instructions are only stored in a volatile memory (SRAM) 22 of the NCK 20.

The DRM library 23 is preferably loaded at the start of the NCK and decrypts the encrypted parts programs intended for processing by the NCK in blocks. Due to the use of the DRM library 23, the encrypted parts program 12 is not visible unprotected in whole or in part in the file system of the CNC control system 2, represented by the non-volatile memory 17. The name DRM (Digital Rights Management) already indicates further possibilities of the DRM library 23. Advantageously, in addition to certain encryption and decryption settings, file rights such as useful life, number of embodiments or additional options (linking to a license, linking to a particular machine, committing to a particular encryption or decryption method, etc.) can also be set.

The exemplary embodiment according to FIG. 3 largely corresponds to that according to FIG. 2, with the difference that FIG. 3 uses so-called asymmetrical encryption. This means, different keys, in particular a key pair are used for encryption and decryption.

Thus, FIG. 3 shows a key pair 18C in the form of a public key 18A, which is not secret and is used for encryption, and a secret private key 18B for decryption. These two keys 18A and 188 are also preferably stored in a memory area 17B of the non-volatile memory 17 inaccessible to the operator of the CNC control system 2 externally.

The key or keys 18 or 18A and 18B can be provided by the manufacturer of the CNC control system, for example in a library provided for this purpose. However, there may also be only one storage location for the key or keys on the CNC control system 2.

Furthermore, the key for encryption and/or decryption can also be defined by an OEM (Original Equipment Manufacturer), which is based on the CNC control system 2 of the controller manufacturer and enriches it with its own functions or applications, as a rule for customers with special requirements. Here, too, the OEM can be provided with a corresponding library by the controller manufacturer.

In addition, an operator of the CNC control system 2 who uses the corresponding CAM software 15 to create a parts program can also determine the key for encryption and/or decryption.

If a key pair (for example key pair 18C) is provided, the keys can also be provided by different companies, for example the public key 18A by a manufacturer of the CNC control system 2 and the key 188 by an OEM.

Advantageously, the key 18 or 18A and 18B are saved in a TPM (Trusted Platform Module) and only made available to particular applications or libraries.

In addition to the key or keys 18 or 18A and 18B, the library preferably also contains information about how the encrypted parts program 12 must be decrypted. In this connection, various decryption methods are possible, which as a rule also depend on the encryption method selected.

FIG. 4 illustrates the essential method steps in carrying out a method according to the invention in the form of a flow chart.

In a first method step S1, workpiece data (CAD data) is provided on a numerical control facility of a machine tool.

In a second method step S2, CAM software is provided on the numerical control facility.

In a method step S3, program instructions for manufacturing the workpiece are generated by means of the machine tool by means of the CAM software in accordance with the workpiece data.

In a method step S4, the generated program instructions are encrypted and stored in a non-volatile memory of the numerical control facility.

In a method step S5, the encrypted program instructions are read out from the non-volatile memory and decrypted.

In a method step S6, the decrypted program instructions are processed by the numerical control facility for controlling the machine tool for manufacturing the workpiece.

1.-15. (canceled)

16. A method for operating a numerical control facility for controlling a manufacturing machine for manufacturing a workpiece, the method comprising:
providing workplace data on the numerical control facility;
providing CAM software on the numerical control facility;
generating program instructions on the numerical control facility by the CAM software in accordance with workpiece data for manufacturing the workpiece by the manufacturing machine;
encrypting the program instructions and saving of the encrypted program instructions in a non-volatile memory of the numerical control facility;
reading out the encrypted program instructions from the non-volatile memory;
decrypting the encrypted program instructions; and
processing of the decrypted program instructions by the numerical control facility for controlling the manufacturing machine for manufacturing the workplace.

17. The method of claim 16, wherein the program instructions form individual sets or blocks of a plurality of sets of a parts program for manufacturing the workplace.

18. The method of claim 16, wherein the encrypted program instructions are decrypted in a NC kernel of the numerical control facility.

19. The method of claim 16, wherein the decrypted program instructions are only made available in a volatile memory of the numerical control facility, in particular the NC kernel.

20. The method of claim 16, wherein the program instructions are decrypted in accordance with metadata associated with the program instructions.

21. The method of claim 16, wherein the decryption of the program instructions is restricted to a particular numerical control facility and/or a particular manufacturing machine and/or a particular license.

22. The method of claim 16, wherein a key is used for encryption and decryption of the program instructions.

23. The method of claim 16, wherein a first key is used for encryption and a second key for decryption of the program instructions.

24. The method of claim 16, wherein encryption and decryption takes place using OpenSSL software.

25. The method of claim 18, wherein the NC kernel manages access rights, accesses the encrypted program instructions, and decrypts and processes the encrypted program instructions by a DRM library.

26. The method of claim 25, wherein the NC kernel accesses the encrypted program instructions, decrypts and processes the encrypted program instructions only after successful authentication by the DRM library.

27. A numerical control facility for performing a method of claim 16.

28. The numerical control facility of claim 27, designed as a CNC control system.

29. A manufacturing machine system, comprising:
a manufacturing machine; and
a numerical control facility configured to:
provide workpiece data on the numerical control facility;
provide CAM software on the numerical control facility;
generate program instructions on the numerical control facility by the CAM software in accordance with workpiece data for manufacturing the workpiece by the manufacturing machine;
encrypt the program instructions and save the encrypted program instructions in a non-volatile memory of the numerical control facility;
read out the encrypted program instructions from the non-volatile memory;
decrypt the encrypted program instructions; and
process the decrypted program instructions for controlling the manufacturing machine for manufacturing the workpiece.

30. The manufacturing machine system of claim 29, wherein the numerical control facility comprises a CNC control system and the manufacturing system comprises a machine tool.
